(19) United States
(12) Patent Application Publication
(10) Pub. No.: US 2026/0082458 A1
(43) Pub. Date: Mar. 19, 2026

(54) STEAMER INSERT AND METHOD OF OPERATING A MICROWAVE OVEN

(71) Applicant: Haier US Appliance Solutions, Inc., Wilmington, DE (US)

(72) Inventors: Bagawathkumar Chellappan, Prospect, KY (US); Blake Ellis, Louisville, KY (US)

(21) Appl. No.: 18/890,015

(22) Filed: Sep. 19, 2024

(51) Int. Cl. H05B 6/64; A23L 5/10; A47J 27/04; A47J 36/32; A47J 37/06

(52) U.S. Cl. CPC H05B 6/645; A23L 5/13; A47J 27/04; A47J 36/32; A47J 37/0629; H05B 6/6435; A47J 2027/043

(57) ABSTRACT

A method of operating a steam cooker assembly in a microwave oven, the steam cooker assembly including a container defining a water reservoir and a target fill line, a steamer insert positioned inside the water reservoir and defining one or more food cavities, and a sensing assembly for monitoring conditions within the water reservoir. The method includes receiving a request to perform a steam cooking cycle using the steam cooker assembly; detecting a water temperature using the sensing assembly positioned in the water reservoir, obtaining a food type and a target doneness, determining cooking parameters based at least in part on the food type and the target doneness, and operating a magnetron of the microwave oven to perform the steam cooking cycle in accordance with the cooking parameters.

### FIELD OF THE INVENTION

The present subject matter relates generally to microwave oven appliances, and more particularly to systems and methods for steaming foods in microwave oven appliances.

### BACKGROUND OF THE INVENTION

Microwave oven appliances generally include a cabinet that defines a cooking chamber for receipt of food items for cooking. These appliances typically include one or more heating elements for generating energy to heat the food items during a cooking process. For example, microwave ovens typically include at least one source of electromagnetic radiation in the microwave frequency range, such as a cavity magnetron. In order to provide selective access to the cooking chamber and to contain food particles and cooking energy (e.g., microwaves) during a cooking operation, microwave appliances further include a door that is typically pivotally mounted to the cabinet.

Consumers may periodically wish to perform a steam cooking process. For example, a user may wish to steam broccoli or other vegetables. These steaming processes are commonly performed on a cooktop where a gas or electric burner is used to boil water and steam the vegetables. Vegetables may be cooked in the microwave, but this manner of cooking often does not yield the same desired finish as steaming vegetables on a cooktop. Moreover, conventional means for cooking vegetables in the microwave expose the vegetables directly to microwave energy and/or saturate the vegetables in water, resulting in soggy vegetables.

Accordingly, a microwave oven and steamer assembly would be desirable. More specifically, a steamer assembly that may be used in a microwave to steam vegetables while protecting them from microwave energy would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a method of operating a cooking assembly in a microwave oven is provided. The cooking assembly includes container defining a water reservoir and a target fill line, a steamer insert positioned inside the water reservoir and defining one or more food cavities, and a sensing assembly for monitoring conditions within the water reservoir. The method includes receiving a request to perform a steam cooking cycle using the cooking assembly, detecting a water temperature using the sensing assembly positioned in the water reservoir, obtaining a food type and a target doneness, determining cooking parameters based at least in part on the food type and the target doneness, and operating a magnetron of the microwave oven to perform the steam cooking cycle in accordance with the cooking parameters.

In another exemplary embodiment, a microwave oven defining a vertical, a lateral, and a transverse direction is provided. The microwave oven includes a cabinet defining a cooking chamber, a magnetron operably coupled to the cooking chamber, a cooking assembly comprising a container defining a water reservoir and a steamer insert positioned inside the water reservoir, a sensing assembly for monitoring conditions within the water reservoir, and a controller in operative communication with the magnetron and the sensing assembly. The controller is configured to receive a request to perform a steam cooking cycle using the cooking assembly, detect a water temperature using the sensing assembly positioned in the water reservoir, obtain a food type and a target doneness, determine cooking parameters based at least in part on the food type and the target doneness, and operate the magnetron of the microwave oven to perform the steam cooking cycle in accordance with the cooking parameters.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective front view of a microwave oven appliance in accordance with an example embodiment of the present disclosure.

FIG. 2 provides a perspective view of the exemplary microwave oven of FIG. 1 with the door in an open position according to exemplary embodiments of the present disclosure.

FIG. 3 provides a front view of a steam cooker assembly including a steamer insert that may be used in the exemplary microwave oven of FIG. 1 according to an exemplary embodiment of the present subject matter.

FIG. 4 provides a front view of the exemplary steam cooker assembly and the steamer insert of FIG. 3 according to an exemplary embodiment of the present subject matter.

FIG. 5 provides an exploded view of the example steamer insert of FIG. 3 according to an exemplary embodiment of the present subject matter.

FIG. 6 provides a method of operating a microwave to perform a steam cooking cycle according to an example embodiment of the present subject matter.

FIG. 7 provides a flow diagram of an example steam cooking cycle according to an example embodiment of the present subject matter.

FIG. 8 provides a flow diagram of an example steam cooking cycle according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As explained herein aspects of the present subject matter are generally directed to a steam cooking accessory for a microwave steam cooker container designed to cook steamed vegetables in the microwave with no microwave energy contaminating the food during the process. This steam cooking accessory may include a metal container with a perforated base, which not only shields the food from direct microwave energy but also evenly conducts heat across its surface and traps the right amount of steam for perfect vegetable steaming. A pressure relief valve may be coupled to the metal steamer lid, which prevents excessive steam buildup, ensuring the cooking process remains safe. The system may also include a plastic insert that serves a dual purpose: it houses a Bluetooth temperature sensor while also being filled with water (e.g., up to a fill line) to act as an insulator, protecting the electronics during cooking. The Bluetooth temperature sensor may provide temperature feedback to the microwave for precise cooking control.

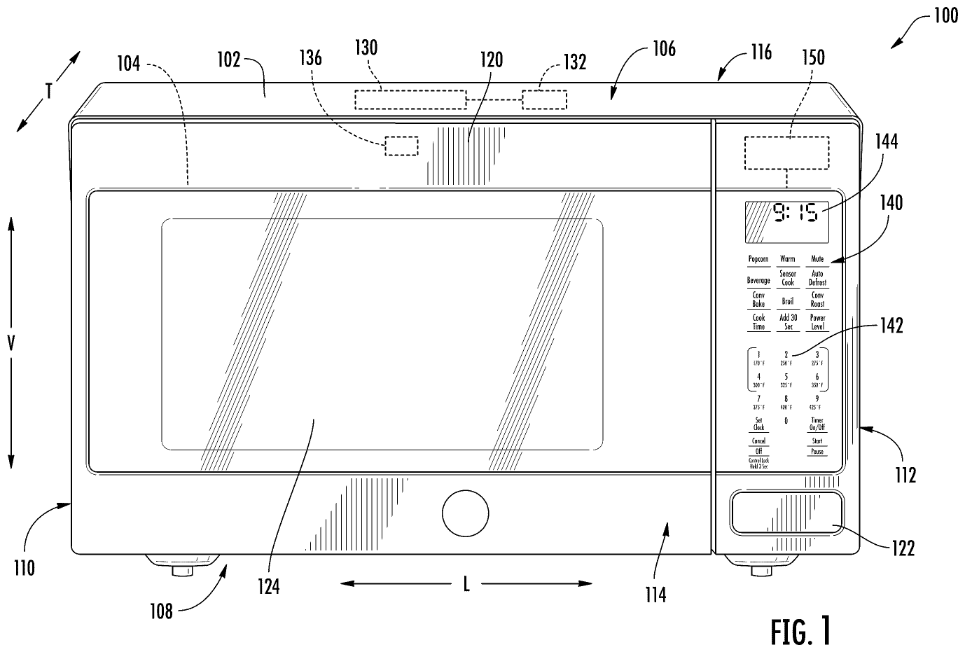

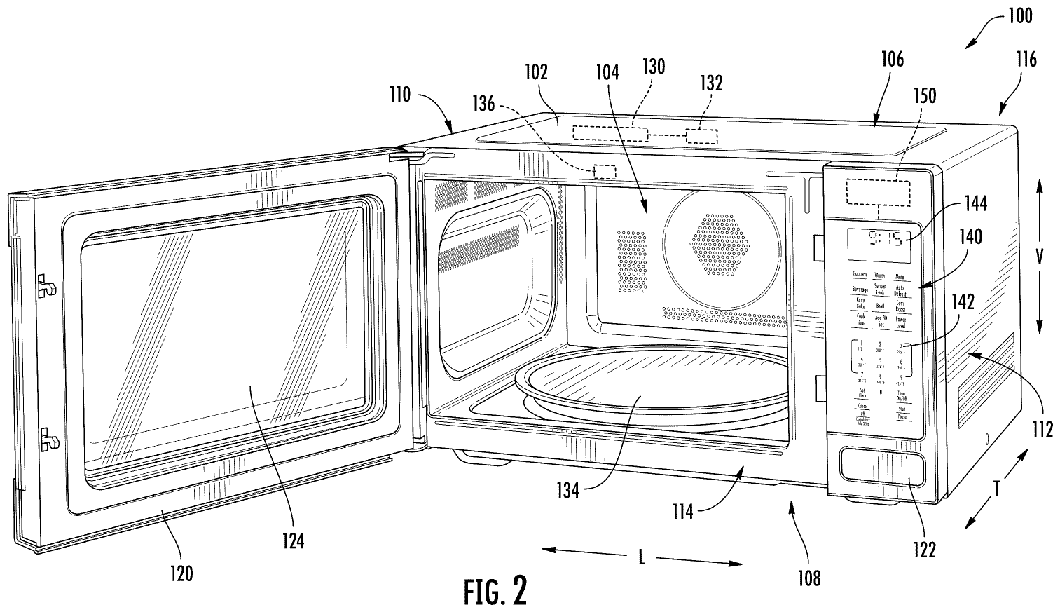

Referring now to the figures, FIG. 1 provides a front view of a microwave oven 100 as may be employed with the present subject matter and FIG. 2 provides a perspective view of microwave oven 100 with the door in the open position. Microwave oven 100 includes an insulated cabinet 102 that defines a cooking chamber 104 for receipt of food items for cooking. As will be understood by those skilled in the art, microwave oven 100 is provided by way of example only, and the present subject matter may be used in any suitable microwave oven, such as a countertop microwave oven, an over-the-range microwave oven, etc. Thus, the example embodiment shown in the figures is not intended to limit the present subject matter to any particular cooking chamber configuration or arrangement.

As illustrated, microwave oven 100 generally defines a vertical direction V, a lateral direction L, and a transverse direction T, each of which is mutually perpendicular, such that an orthogonal coordinate system is generally defined. Cabinet 102 of microwave oven 100 extends between a top 106 and a bottom 108 along the vertical direction V, between a first side 110 (left side when viewed from front) and a second side 112 (right side when viewed from front) along the lateral direction L, and between a front 114 and a rear 116 along the transverse direction T.

Microwave oven 100 includes a door 120 that is rotatably attached to cabinet 102 in order to permit selective access to cooking chamber 104. A handle may be mounted to door 120 to assist a user with opening and closing door 120 in order to access cooking chamber 104. As an example, a user can pull on the handle mounted to door 120 to open or close door 120 and access cooking chamber 104. Alternatively, microwave oven 100 may include a door release button 122 that disengages or otherwise pushes open door 120 when depressed. Glass windowpanes 124 provide for viewing the contents of cooking chamber 104 when door 120 is closed and also assist with insulating cooking chamber 104.

Microwave oven 100 is generally configured to heat articles, e.g., food or beverages, within cooking chamber 104 using electromagnetic radiation. Microwave appliance 100 may include various components which operate to produce the electromagnetic radiation, as is generally understood. For example, microwave appliance 100 may include a microwave heating assembly 130 which may include a magnetron (such as, for example, a cavity magnetron), a high voltage transformer, a high voltage capacitor and a high voltage diode.

According to exemplary embodiments, microwave oven 100 may further include an inverter power supply 132 that is operably coupled to microwave heating assembly 130 to provide energy from a suitable energy source (such as an electrical outlet) to microwave heating assembly 130, e.g., the magnetron. The magnetron may convert the energy to electromagnetic radiation, specifically microwave radiation. Microwave heating assembly 130 and/or inverter power supply 132 may include other suitable components, such as a capacitor that generally connects the magnetron and power supply, such as via high voltage diode, to a chassis. Microwave radiation produced by the magnetron may also be transmitted through a waveguide to cooking chamber 104.

As would be appreciated by one having ordinary skill in the art, inverter power supply 132 allows the magnetron's analog electric field intensity to be adjusted between various power levels, such as between 10% and 100% of the total power capacity. By contrast, with conventional non-inverter power supplies, the electric field intensity is either 100% or 0%, and power levels are made using a timed duty cycle. For example, a non-inverter power supply set for a 50% power level would turn the magnetron ON at 100% output power for 15 seconds, and then OFF for 15 seconds. At power levels less than 100%, inverter power supply 132 has much better heating uniformity and less penetration depth—ideal for heating the water while avoiding direct heating of the food with microwave energy.

The structure and intended function of microwave ovens are generally understood by those of ordinary skill in the art and are not described in further detail herein. According to alternative embodiments, microwave oven may include one or more heating elements, such as electric resistance heating elements, gas burners, other microwave heating elements, halogen heating elements, or suitable combinations thereof, are positioned within cooking chamber 104 for heating cooking chamber 104 and food items positioned therein.

Microwave oven 100 may include additional features to improve heating uniformity and precision. For example, according to an exemplary embodiment, microwave oven 100 includes a turntable 134 rotatably mounted within cooking chamber 104. Turntable 134 may be selectively rotated during a cooking process to ensure improved temperature uniformity for the object being heated. In addition, microwave oven 100 may include an infrared temperature sensing array 136 that can measure temperatures across the entire bottom of the cooking chamber 104. Temperature sensing array 136 may detect temperatures at various distinct temperature locations, may associate certain locations with the food items being cooked, and may use a subset of the temperature data as feedback for regulating inverter power supply 128 and microwave heating assembly 126 for improved precision. For example, temperature sensing array 136 may include one or more infrared sensors mounted to a top of cooking chamber 104 for periodically or continuously monitoring a surface temperature of the water in a steam cooker assembly.

Referring again to FIG. 1, a user interface panel 140 and a user input device 142 may be positioned on an exterior of the cabinet 102. The user interface panel 140 may represent a general purpose Input/Output (“GPIO”) device or functional block. In some embodiments, the user interface panel 140 may include or be in operative communication with user input device 142, such as one or more of a variety of digital, analog, electrical, mechanical or electro-mechanical input devices including rotary dials, control knobs, push buttons, and touch pads. The user input device 142 is generally positioned proximate to the user interface panel 140, and in some embodiments, the user input device 142 may be positioned on the user interface panel 140. The user interface panel 140 may include a display component 144, such as a digital or analog display device designed to provide operational feedback to a user.

Generally, microwave oven 100 may include a controller 150 in operative communication with the user input device 142. The user interface panel 140 of the microwave oven 100 may be in communication with the controller 150 via, for example, one or more signal lines or shared communication busses, and signals generated in controller 150 operate microwave oven 100 in response to user input via the user input devices 142. Input/Output (“I/O”) signals may be routed between controller 150 and various operational components of microwave oven 100. Operation of microwave oven 100 can be regulated by the controller 150 that is operatively coupled to the user interface panel 140.

Controller 150 is a “processing device” or “controller” and may be embodied as described herein. Controller 150 may include a memory and one or more microprocessors, microcontrollers, application-specific integrated circuits (ASICS), CPUs or the like, such as general or special purpose microprocessors operable to execute programming instructions or micro-control code associated with operation of microwave oven 100, and controller 150 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, a controller 150 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Aspects of the present subject matter are generally directed to systems and methods for implementing a steam cooking process in a microwave oven, such as microwave oven 100. More particularly, according to exemplary embodiments of the present subject matter, cooking chamber 104 is configured for receipt of a steam cooker assembly 200 (e.g., on turntable 134) for facilitating a steam cooking process within microwave oven 100. According to exemplary embodiments, turntable 134 is rotated during the steam cooking process for improved thermal uniformity. As would be appreciated by one having ordinary skill in the art, a steam cooking process is a type of cooking where a food item (such as meat) is vacuum sealed in a bag and submerged in a bath of water maintained at a desired temperature until the meat reaches the desired internal temperature. Notably, precise temperature control is very desirable for steam cooking processes. Moreover, as explained in more detail below, steam cooker assembly 200 may be used for non-steam cooking applications, e.g., such as steaming vegetables.

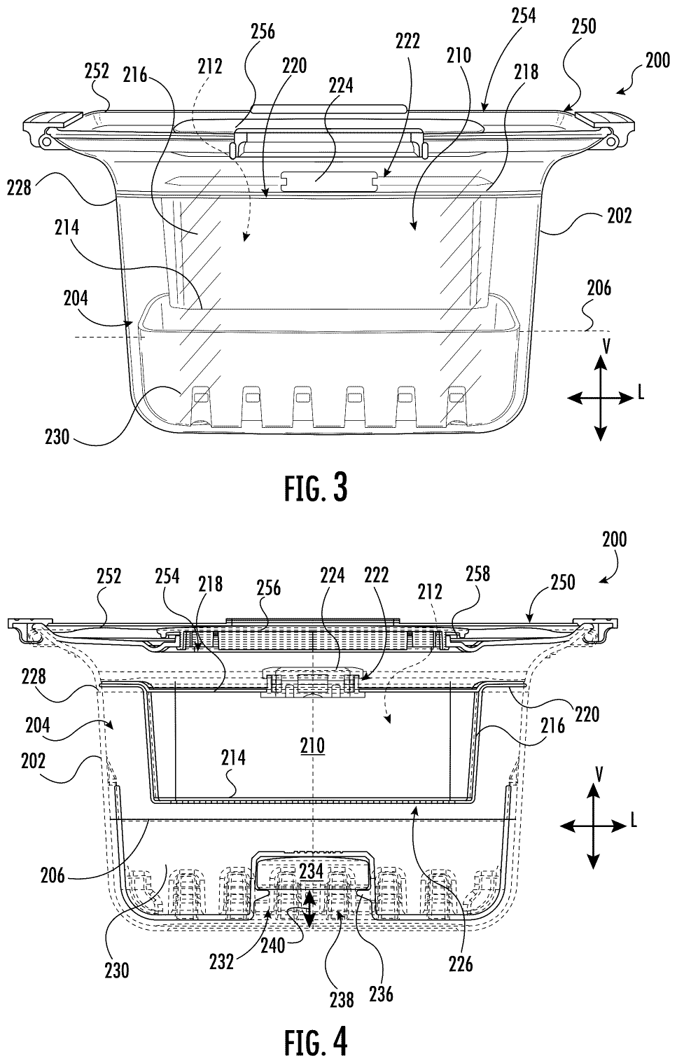

Referring now specifically to FIGS. 3 through 5, steam cooker assembly 200 will be described in detail according to an exemplary embodiment of the present subject matter. As mentioned above, steam cooker assembly 200 is generally configured for receipt within cooking chamber 104 microwave oven 100 to facilitate a cooking process. However, it should be appreciated that the present subject matter is not limited to the specific construction of steam cooker assembly 200 or to the particular application described, e.g., use within microwave oven 100.

Referring now to the figures, steam cooker assembly 200 generally includes a steam cooking container 202 that defines a water reservoir 204. In general, steam cooking container 202 may be a watertight, open-top container having a bottom wall and a plurality of sidewalls that are joined and configured for containing a volume of liquid (e.g., such as water) to facilitate the cooking process. Although the cooking process is described herein as the one with water, it should be appreciated that other suitable cooking foods are possible and within the scope of the present subject matter. In addition, steam cooking container 202 may define a target fill line 206, e.g., a line to which water should be filled before performing one or more cooking processes using steam cooker assembly 200. For example, target fill line 206 may vary depending on the type of cooking being performed (e.g., steam cooking, steaming, etc.)

In addition, steam cooker assembly 200 may include a steamer insert 210 that may be positioned within water reservoir 204 to facilitate a steam cooking process, as described in more detail below. As illustrated, steamer insert 210 may define one or more food cavities 212 for receiving food items to facilitate the steam cooking process. More specifically, steamer insert may include a bottom wall 214 and a plurality of sidewalls 216 that define a single, open-top food cavity 212, though steamer insert 210 may define more food cavities 212 according to alternative embodiments.

Steam cooker assembly 200 may further include a steamer lid 218 configured for receipt on top of steamer insert 210, e.g., at least partially enclosing food cavity 212. According to the illustrated embodiment, steamer lid 218 is seated on top of a top flange 220 of steamer insert 210. According to alternative embodiments, steamer lid 218 may be secured with one or more clips, fasteners, etc. Steamer lid 218 may define a pressure relief aperture 222 and a pressure relief valve 224 may be operably coupled to steamer lid 218 over pressure relief aperture 222. Pressure relief valve 224 may be any suitable type of valve or device that opens at a target pressure to release air and facilitate an improved steam cooking process.

According to an example embodiment, steamer insert 210 and steamer lid 218 may be formed from a metallic material, such as stainless steel. In this manner, microwave energy generated by microwave heating assembly 130 may not penetrate into food cavity 212 and the food items may be shielded from such microwave energy. Bottom wall 214 and/or sidewalls 216 may be perforated to include a plurality of apertures 226 to facilitate the introduction of steam into food cavity 212. Other constructions of steamer insert and steamer lid 218 are possible and within the scope of the present subject matter.

In addition, bottom wall 214 may be positioned at or above target fill line 206, thereby suspending food cavity 212 above the water to prevent saturating or soaking the food items being steamed. For example, steam cooking container 202 may define one or more standoffs or a support shoulder 228 for supporting steamer insert 210 at the desired vertical position. In this regard, top flange 220 of steamer insert 210 may rest on support shoulder 228 of steam cooking container 202. According to alternative embodiments, one or more support structure or legs may extend from steam cooking container 202 or steamer insert 210 to position food cavity 212 above the target fill line 206.

Referring still to FIGS. 3 through 5, steam cooker assembly 200 may further include a support insert 230 positioned at a bottom of water reservoir 204. According to the illustrated embodiment, steamer insert 210 may be positioned above support insert 230 or may be seated directly on top of support insert 230. As best shown in FIG. 4, support insert 230 may define a recess 232 that is generally configured to receive a sensing assembly 234, which will be described in more detail below. Specifically, support insert 230 may include support flanges 236 that receive sensing assembly 234 and suspend it above a bottom wall of steam cooking container 202. In addition, support insert 230 may define a plurality of dimples, recesses, or grooves in its sidewall, e.g., to capture heated water.

According to an example embodiment, support flanges 236 may support sensing assembly 234 within recess 232 such that a heating gap 238 is defined between sensing assembly 234 and steam cooking container 202. In this regard, heating gap 238 is a space defined between sensing assembly 234 and steam cooking container 202 and/or between sensing assembly 234 and target fill line 206. Notably, heating gap 238 may be sized such that microwave energy does not penetrate through the water to reach sensing assembly 234, thereby reducing the likelihood of damage or inoperability of sensing assembly 234.

Notably, when heating gap 238 is appropriately sized, substantially all of the microwave energy is absorbed within heating gap 238 (e.g., such that there is negligible interaction with sensing assembly 234). Accordingly, heating gap 238 may generally define a gap length 240 that is measured between steam cooking container 202 and sensing assembly 234. According to exemplary embodiments, gap length 240 may be between about 5 millimeters and 40 millimeters, between about 10 millimeters and 30 millimeters, or about 20 millimeters. It should be appreciated that gap length 240 may vary while remaining within the scope of the present subject matter. For example, the desirable gap length may vary based on the intensity of microwave energy or based on any other suitable factors.

According to the illustrated embodiment, steam cooker assembly 200 may further include a lid assembly 250 that is removably mounted to steam cooking container 202 over water reservoir 204, e.g., to provide selective access to the plurality of food cavities 212. Specifically, according to the illustrated embodiment, lid assembly 250 includes a container lid 252 that is seated on steam cooking container 202 and defines a central opening 254. In addition, a lid cap 256 is positioned over central opening 254. Lid cap 256 may be removably received onto container lid 252, e.g., via a snap-fit mechanism.

According to example embodiments, lid assembly 250 may define one or more vent holes 258 that are hidden to maintain attractive appearance while allowing minimal moisture to vent. This may prevent pressure build-up, excessive evaporation, cavity condensation, and door fogging. According to the illustrated embodiment, vent holes 258 are defined between container lid 252 and lid cap 256, e.g., at the corners thereof. These vent holes 258 may define a tortuous path from water reservoir 204 to an ambient environment. For example, vent holes may wind between internal passageways of container lid 252 and/or lid cap 256 and may not provide direct line of sight into water reservoir 204, thereby permitting moisture evacuation while minimizing spillage.

According to exemplary embodiments, steam cooking container 202, steamer insert 210, support insert 230, and lid assembly 250 may be formed from any suitable materials and have any suitable construction to improve the steam cooking process. For example, according to exemplary embodiments, all of these components may be injection molded with a food-grade polymer material. Alternatively, these features may be formed from glass, food grade plastic, silicone, stainless steel, ceramic, glass, etc. Accordingly, it should be appreciated that various features of steam cooker assembly 200 may be formed from any suitably rigid material. For example, according to exemplary embodiments, steam cooking container 202, steamer insert 210, support insert 230, and lid assembly 250 may be formed by injection molding, e.g., using a suitable plastic material, such as injection molding grade Polybutylene Terephthalate (PBT), Nylon 6, high impact polystyrene (HIPS), acrylonitrile butadiene styrene (ABS), or any other suitable blend of polymers. Alternatively, according to the exemplary embodiment, these components may be compression molded, e.g., using sheet molding compound (SMC) thermoset plastic or other thermoplastics. According to still other embodiments, portions of steam cooker assembly 200 may be formed from any other suitable rigid material.

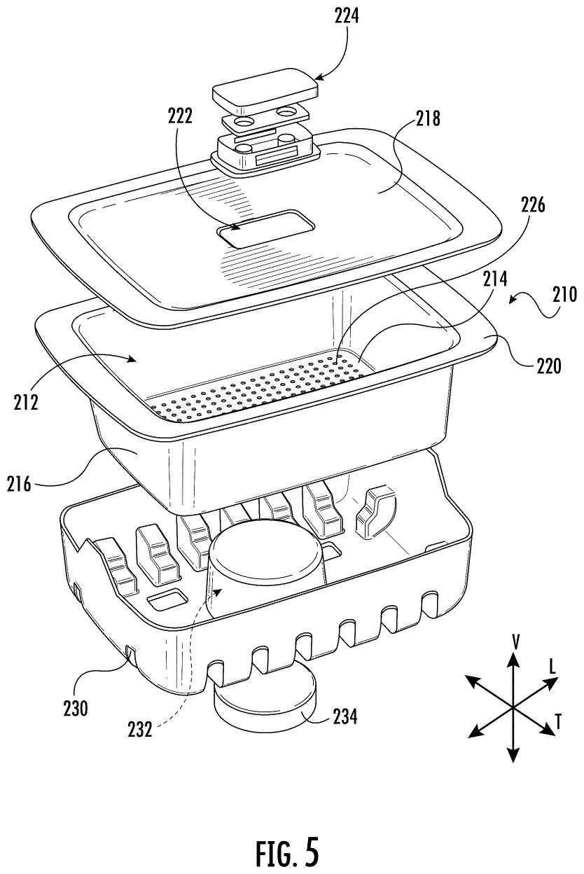

Referring now FIGS. 4 and 5, sensing assembly 234 will be described in more detail. Sensing assembly 234 may be configured as a stand-alone measuring device that may be utilized with steam cooker assembly 200 to measure one or more various parameters associated with operation of steam cooker assembly 200. For example, sensing assembly 234 may be used to measure the temperature or water level of water within water reservoir 204. Accordingly, sensing assembly 234 may include one or more sensors for measuring the various parameters associated with the operation of a microwave appliance 100 or steam cooker assembly 200. In some embodiments, sensing assembly 234 may include a temperature sensor, such as an infrared thermometer for contactless temperature measurements, a probe thermometer including a probe insertable positioned within the water, and/or the like.

In addition, or alternatively, sensing assembly 234 may include a fluid sensor, e.g., configured to measure one or more parameters associated with a presence of fluid and/or a level of fluid within steam cooking container 202. Specifically, in some exemplary embodiments, the fluid sensor is an ultrasonic fluid sensor that emits sound waves. By receiving and analyzing reflected sound waves, such as the speed of the reflected sound waves, the presence of water or the water level may be detected. It should be appreciated that the ultrasonic fluid sensor may analyze any other suitable property of the emitted and/or reflected sound waves, such as the time of flight or time taken to receive a reflected sound wave once the emitted sound wave has been emitted, frequency, and/or the like. According to still other embodiments, sensing assembly 234 may include an optical sensor or camera that may be used to obtain an image that may be analyzed to detect the water level.

Furthermore, in some embodiments, sensing assembly 234 may include a chargeable battery. The chargeable battery may be positioned within a housing of sensing assembly 234 and may be configured to provide electrical power to sensing assembly 234, such as to all components of sensing assembly 234 that operate using electrical power. As such, sensing assembly 234 may also include a charging interface or port which may be operatively/electrically connectable to an external charging device for charging the chargeable battery of sensing assembly 234. Sensing assembly 234 may record data, log data, and communicate data remotely, e.g., such as with controller 150 of microwave oven 100 and/or to a remote device such as a mobile phone.

Now that the construction of microwave oven 100 and steam cooker assembly 200 have been described according to example embodiments of the present subject matter, an exemplary method 300 of operating a microwave oven or steam cooker assembly to facilitate a steam cooking cycle will be described. Although the discussion below refers to the exemplary method 300 of operating microwave oven 100, one skilled in the art will appreciate that the exemplary method 300 is applicable to the operation of a variety of other microwave and/or steam cooking appliances.

In exemplary embodiments, the various method steps as disclosed herein may be performed by controller 150 or a separate, dedicated controller. In this regard, as described herein, controller 150 of oven appliance 100 may implement all steps of method 300. However, it should be appreciated that according to alternative embodiments, controller 150 may offload the performance of steps described herein, e.g., by communicating with a network or a remote server. Other distributed computing arrangements are possible and within the scope of the present subject matter.

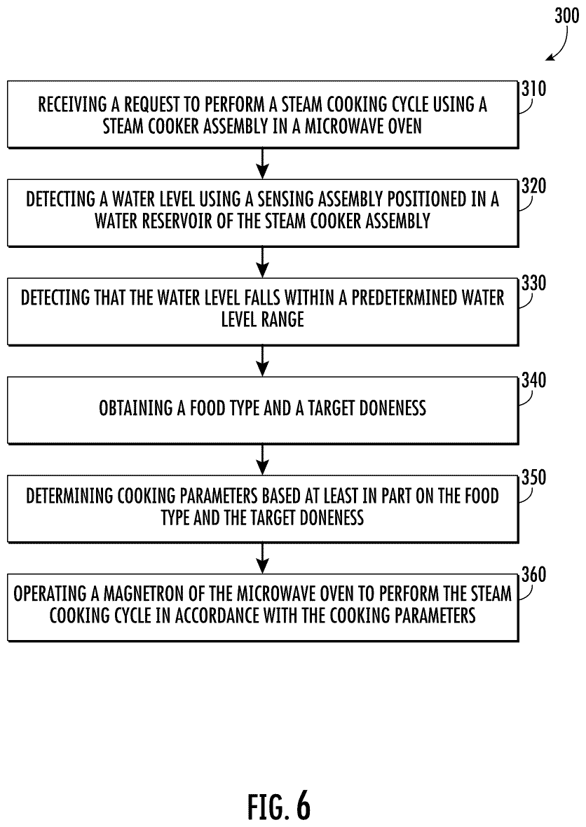

Specifically, referring now to FIG. 6, method 300 includes, at step 310, receiving a request to perform a steam cooking cycle using a steam cooker assembly. In this regard, continuing the example from above, a user may utilize user interface panel 140 or a remote device (e.g., a software application on a mobile phone) to initiate the steam cooking cycle, input cycle parameters, specify food type or desired doneness level, etc. The user may also assemble steamer insert 210 within steam cooking container 202, add the food to be steamed, connect sensing assembly 234, and position steam cooking container 202 in cooking chamber 104 prior to commencement of the steam cooking cycle.

After the steam cooking container 202 has been added to cooking chamber 104, door 120 has been closed, and the steam cooking cycle has been requested, step 320 may include detecting a water level using the sensing assembly positioned in the water reservoir. In this regard, sensing assembly 234 may use one or more sensors to ensure a desirable amount of water is present to facilitate a safe steam cooking cycle. For example, step 330 may include determining that the water level falls within a predetermined water level range, exceeds a predetermined level, reaches the target fill line 206, etc. By contrast, method 300 may include determining that the water level falls outside the predetermined water level range and providing a user notification (e.g., through user interface panel 140 or a remote device) to add or remove water from water reservoir 204.

Once the water level has been determined to be suitable, step 340 may include obtaining a food type and a target doneness. This may be based on user input or may be predetermined for a selected steam cooking cycle. Step 350 may include determining cooking parameters based at least in part on the food type and the target doneness. For example, determining the cooking parameters based at least in part on the food type and the target doneness may include determining a target cooking time based on the food type and the target doneness or determining a power schedule comprising one or more power levels and one or more cooking durations. In this regard, for example, a single steam cooking cycle may include multiple stages having at least one of different power levels or different cooking durations.

After the cooking parameters have been determined, step 360 may generally include operating a magnetron of the microwave oven to perform the steam cooking cycle in accordance with the cooking parameters. During the steam cooking cycle, sensing assembly 234 may be used to provide useful information, such as remaining water levels, water temperatures, etc. For example, sensing assembly 234 may be used to obtain a water temperature using a temperature sensor of the sensing assembly and the magnetron may be operated to adjust the water temperature to a target cooking temperature. In this regard, if the water temperature is below the target cooking temperature, the magnetron may be operated at a first power level, e.g., a reheating or elevated power level to quickly increase the water temperature. By contrast, when the water temperature has reached or is approaching the target cooking temperature, the magnetron may be operated at a second power level, the second power level being lower than the first power level. In this regard, for example, the second power level may be intended to maintain the water temperature as opposed to increase the water temperature.

Notably, operation of the magnetron while taking temperature measurements may result in errors. In this regard, for example, the generated microwave energy may affect the temperature sensing process or the transmission of temperature data to controller 150. Accordingly, method 300 may include deenergizing the magnetron prior to obtaining the water temperature. In addition, the measured water temperature may be used to provide feedback to the user regarding the remaining cooking time or the status of the steam cooking cycle. In this regard, method 300 may include estimating a remaining cook time based at least in part on an elapsed cook time and the water temperature and communicating this information to the user.

Method 300 may further include steps for determining that sensing assembly 234 is not functioning properly and taking corrective action. For example, method 300 may include identifying an absence of connection with the sensing assembly and notifying user to rectify the absence of the connection with the sensing assembly. Connection issues may occur for a variety of reasons, e.g., low battery, faulty equipment, incorrect installation of sensing assembly, etc. Method 300 may include advising a user regarding corrective action that should be taken to resolve these connectivity issues.

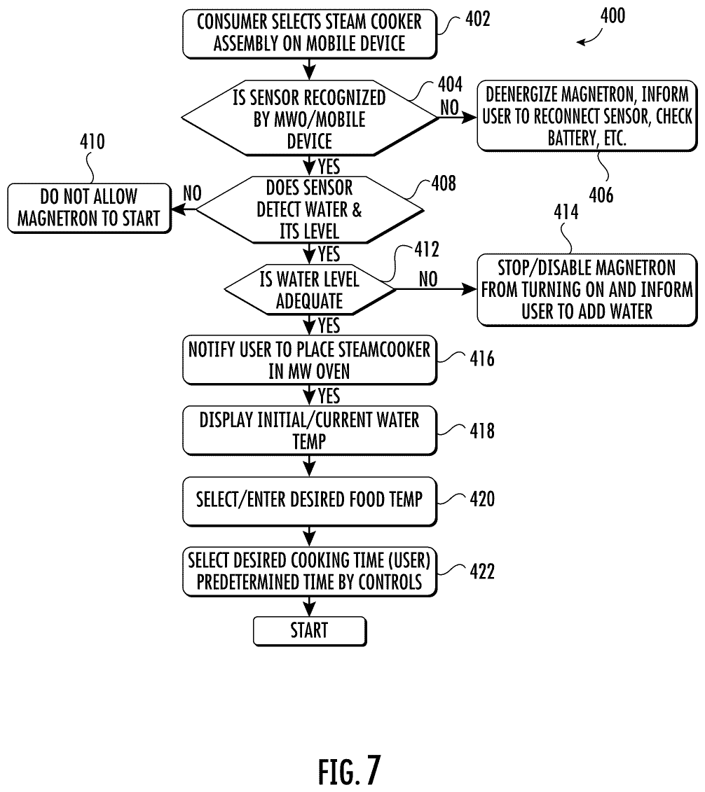

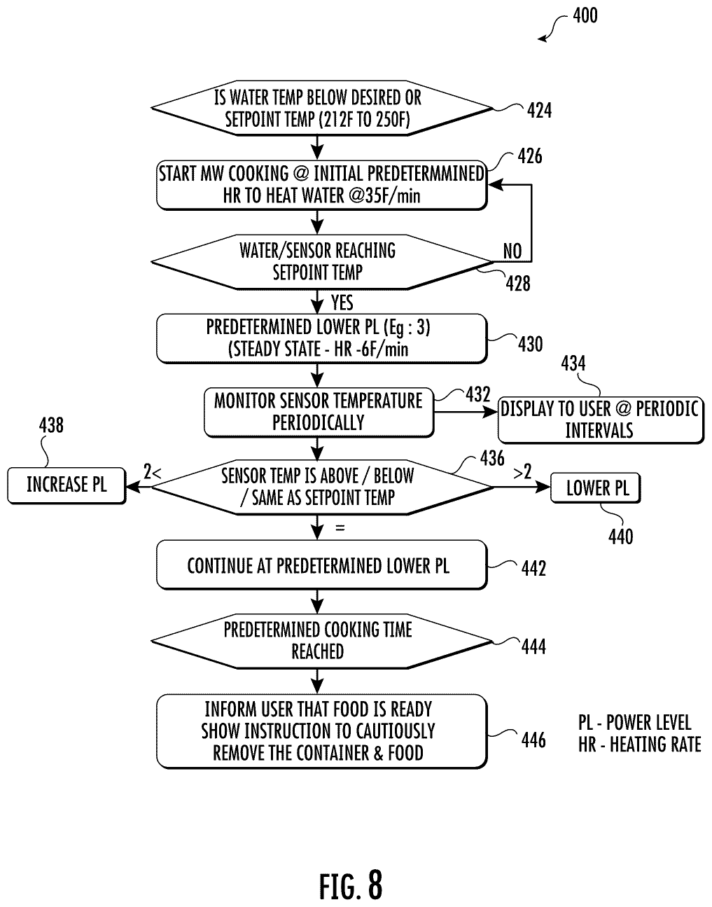

Referring now to FIGS. 7 and 8, an example flow diagram or method 400 of performing a steam cooking cycle will be described according to another example embodiment. As shown, method 400 includes, at step 402, determining that a user has selected a steam cooking cycle using the steam cooker assembly, e.g., via user interface panel 140 or through a remote device. Step 404 may include recognizing or identifying the sensing assembly through the microwave or remote device. If the sensing assembly is not recognized, step 406 may include deenergizing the magnetron, informing the user to check the sensing assembly or battery, etc.

If the sensing assembly is recognized and connected, step 408 may include detecting the presence of water and/or measuring the water level. If the water level is insufficient, step 410 may include locking out the magnetron and informing the user to take corrective action. Step 412 may include determining whether the water level within the steam cooking container is sufficient for performing the steam cooking cycle. If the water level is inadequate, step 414 may include disabling the magnetron and informing the user to add or remove water.

If the water level is determined to be adequate, step 416 may include instructing the user to place the steam cooking container in the cooking chamber (if it is not there already). Step 418 may include displaying the initial water temperature, the current water temperature, the target water temperature, or other useful information to the user. Step 420 may include selecting, entering, or displaying the desired food temperature or other suitable cooking information. Step 422 may include selecting or determining the desired cooking times, power schedules, etc. for performing the steam cooking cycle.

Proceeding to FIG. 8, method 400 may further include, at step 424, determining that the water temperature is below the setpoint or target water temperature. If the water temperature is lower than the setpoint, step 426 may include operating the microwave at a first power level to heat the water up at a predetermined rate (e.g., such as 35 degrees Fahrenheit per minute). Step 428 may include determining whether the temperature setpoint is reached, and if it is, step 430 may include operating the microwave at a second, lower power level to maintain the temperature of the water during the steam cooking cycle.

Steps 432 and 434 may include periodically measuring the water temperature and reporting it to the user. Step 436 may include comparing the measured temperature to the setpoint temperature. If the temperature is lower than the setpoint temperature by a predetermined number of degrees (e.g., 2 degrees Fahrenheit), step 438 may include increasing the power level. By contrast, if the temperature is higher than the setpoint temperature by a predetermined number of degrees (e.g., 2 degrees Fahrenheit), step 440 may include decreasing the power level. If the measured temperature is roughly equal to the target temperature, step 442 may include maintaining the power level until the predetermined cooking time has been reached at step 444. Step 446 may include informing the user that the steam cooking cycle is complete and the food is ready for consumption.

FIGS. 6 through 8 depict steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of methods 300 and 400 are explained using microwave oven appliance 100 and steam cooker assembly 200 as an example, it should be appreciated that this method may be applied to the operation of any microwave steam cooking accessory.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a steam cooker assembly in a microwave oven, the steam cooker assembly comprising a container defining a water reservoir and a target fill line, a steamer insert positioned inside the water reservoir and defining one or more food cavities, and a sensing assembly for monitoring conditions within the water reservoir, the method comprising:
receiving a request to perform a steam cooking cycle using the steam cooker assembly;
detecting a water temperature using the sensing assembly positioned in the water reservoir;
obtaining a food type and a target doneness;
determining cooking parameters based at least in part on the food type and the target doneness; and
operating a magnetron of the microwave oven to perform the steam cooking cycle in accordance with the cooking parameters.

2. The method of claim 1, wherein determining the cooking parameters based at least in part on the food type and the target doneness comprises:
determining a target cooking time based on the food type and the target doneness.

3. The method of claim 1, wherein determining the cooking parameters based at least in part on the food type and the target doneness comprises:
determining a power schedule comprising one or more power levels and one or more cooking durations.

4. The method of claim 3, wherein the power schedule comprises multiple stages having at least one of different power levels or different cooking durations.

5. The method of claim 1, further comprising:
monitoring a water level using the sensing assembly positioned in the water reservoir; and
determining that the water level falls within a predetermined water level range before operating the magnetron of the microwave oven to perform the steam cooking cycle in accordance with the cooking parameters.

6. The method of claim 5, further comprising:
determining that a water level falls outside the predetermined water level range; and
providing a user notification to add water to the water reservoir.

7. The method of claim 1, wherein the sensing assembly comprises an optical sensor, the method further comprising:
obtaining an image using the optical sensor; and
analyzing the image to detect a water level.

8. The method of claim 1, wherein the sensing assembly comprises a temperature sensor, the method further comprising:
obtaining a water temperature using the temperature sensor of the sensing assembly; and
operating a magnetron to adjust the water temperature to a target cooking temperature.

9. The method of claim 8, wherein operating the magnetron to adjust the water temperature to the target cooking temperature comprises:
determining that the water temperature is below the target cooking temperature; and
operating the magnetron at a first power level.

10. The method of claim 9, wherein operating the magnetron to adjust the water temperature to the target cooking temperature comprises:
determining that the water temperature has reached the target cooking temperature; and
operating the magnetron at a second power level, the second power level being lower than the first power level.

11. The method of claim 8, further comprising:
deenergizing the magnetron prior to obtaining the water temperature.

12. The method of claim 1, wherein the sensing assembly comprises a temperature sensor, the method further comprising:
obtaining a water temperature using temperature sensor of the sensing assembly; and
estimating a remaining cook time based at least in part on an elapsed cook time and the water temperature.

13. The method of claim 1, further comprising:
identifying an absence of connection with the sensing assembly; and
notifying a user to rectify the absence of the connection with the sensing assembly.

14. A microwave oven defining a vertical, a lateral, and a transverse direction, the microwave oven comprising:
a cabinet defining a cooking chamber;
a magnetron operably coupled to the cooking chamber;
a steam cooker assembly comprising a container defining a water reservoir and a steamer insert positioned inside the water reservoir;
a sensing assembly for monitoring conditions within the water reservoir; and
a controller in operative communication with the magnetron and the sensing assembly, the controller being configured to:
receive a request to perform a steam cooking cycle using the steam cooker assembly;
detect a water temperature using the sensing assembly positioned in the water reservoir;
obtain a food type and a target doneness;
determine cooking parameters based at least in part on the food type and the target doneness; and
operate the magnetron of the microwave oven to perform the steam cooking cycle in accordance with the cooking parameters.

15. The microwave oven of claim 14, wherein determining the cooking parameters based at least in part on the food type and the target doneness comprises:
determining a target cooking time based on the food type and the target doneness.

16. The microwave oven of claim 14, wherein determining the cooking parameters based at least in part on the food type and the target doneness comprises:
determining a power schedule comprising one or more power levels and one or more cooking durations.

17. The microwave oven of claim 16, wherein the power schedule comprises multiple stages having at least one of different power levels or different cooking durations.

18. The microwave oven of claim 14, wherein the controller is further configured to:
detect a water level using the sensing assembly positioned in the water reservoir;
determine that the water level falls outside the predetermined water level range; and
provide a user notification to add water to the water reservoir.

19. The microwave oven of claim 14, wherein the sensing assembly comprises a temperature sensor, and wherein the controller is further configured to:
obtaining a water temperature using the temperature sensor of the sensing assembly; and
operating a magnetron to adjust the water temperature to a target cooking temperature.

20. The microwave oven of claim 19, wherein operating the magnetron to adjust the water temperature to the target cooking temperature comprises:
determining that the water temperature is below the target cooking temperature; and
operating the magnetron at a first power level.
